(19) United States
(12) Patent Application Publication
(10) Pub. No.: US 2026/0337037 A1
(43) Pub. Date: Oct. 29, 2026

(54) SILICA COMPOSITIONS, PROCESSES FOR PREPARING SILICA, AND METHODS FOR IMPROVING DRAINAGE IN PAPERMAKING PROCESSES

(71) Applicant: ECOLAB USA Inc., St. Paul, MN (US)

(72) Inventors: Qianhe WANG, Shanghai (CN); Zhi CHEN, Lisle, IL (US); Shaoxiang NI, Shanghai (CN)

(73) Assignee: ECOLAB USA Inc., St. Paul, MN (US)

(21) Appl. No.: 19/735,917

(22) Filed: Jul. 9, 2026

Related U.S. Application Data
(63) Continuation-in-part of application No. 19/354,645, filed on Oct. 9, 2025.
(60) Provisional application No. 63/706,111, filed on Oct. 11, 2024.

(51) Int. Cl. C01B 33/193; D21H 17/68

(52) U.S. Cl. CPC C01B 33/193; D21H 17/68; C01P 2006/22

(57) ABSTRACT

The present disclosure generally relates to improved batch processes for preparing silica, silica compositions, and methods for improving drainage in papermaking processes. The processes may include a buffer. The turbidity and/or pH may be measured during the processes. The processes may include, for example, producing silica until a predetermined turbidity value and/or a predetermined pH value has been achieved. The prepared silica may have advantages such as enhanced performance and/or storage stability.

### CROSS-REFERENCE TO RELATED APPLICATIONS

This application is a Continuation-In-Part of U.S. patent application Ser. No. 19/354,645, filed Oct. 9, 2025, which claims priority to U.S. Application No. 63/706,111, filed on Oct. 11, 2024, the contents of each of which are incorporated by reference in their entirety.

### TECHNICAL FIELD

The present disclosure generally relates to batch processes for preparing silica for papermaking, silica compositions, and methods for improving drainage processes in papermaking processes.

### BACKGROUND

Silica plays a vital role in papermaking by, e.g., improving retention, drainage, formation, sheet structure, surface properties, sizing and strength.

Several practical factors currently limit the commercial use of silica. For instance, silica solutions are often relatively dilute, making it impractical to ship large volumes long distances. Also, silica is prone to gelling and to forming silicate deposits in equipment used to prepare the product. These problems may, in certain circumstances, be overcome by equipment design and trained personnel in a factory environment, but they present greater difficulty in field applications in which the equipment is ideally relatively easy to operate and maintain.

The on-site preparation of silica typically occurs via a continuous or batch process. Batch process reactions allow for the monitoring of silica formation and terminating the reaction before gel formation occurs and the viscosity becomes too high. Batch process reactions allow for easy cleaning of the deposit, easier control on the dilution step and can be used for both unmodified and modified silica production. However, traditional batch processes involve producing and aging the silica in large mixing and holding tanks, which not only are expensive but also introduce the problems of product nonuniformity and process control inherent in a batch process.

In contrast to the batch process, the continuous process involves silica production occurring consistently without stopping. Continuous reactions typically run the risk of gel formation in the process pipe and stopping flow or the structure of the silica product is not optimized for performance. Additionally, continuous reactions can be challenging due to the need for precise control on pH, difficulty of cleaning deposit, and dependency of flow rate on the reaction. Despite these disadvantages, silica is typically prepared commercially using a continuous method.

One advantage of on-site silica over conventional silica is that the former may avoid the transportation of large volumes of water. Other advantages of on-site silica as compared to traditional silica include, e.g., the elimination of ion exchange resins and the ability to generate silica with a large surface area.

### BRIEF SUMMARY

In some aspects, the present disclosure provides a stable batch process for preparing silica.

In some aspects, the present disclosure provides a batch process for preparing silica, the process comprising:
mixing a silicate salt (e.g. sodium silicate, calcium silicate, ammonium silicate or potassium silicate), an acid, and a buffer (such as boric acid, carbonate buffer, ammonium hydroxide, or Tris buffer), and water in a vessel (e.g., reaction tank) to obtain a mixture, wherein the mixture has a pH of about 8.5 to about 10;
aging the mixture for a period of time sufficient to obtain a turbidity of about 10 Nephelometric Turbidity units (NTU) to about 50 NTU to obtain an unmodified silica, wherein the silica has a S-value of about 2 to about 10; and
diluting the mixture with water to obtain silica with a concentration of about 0.1 wt. % to about 2.6 wt. %.

In some aspects, the present disclosure provides an unmodified silica prepared according to a batch process for preparing silica disclosed herein.

In some aspects, the present disclosure provides a modified silica prepared according to a batch process for preparing silica disclosed herein.

In some aspects, the present disclosure provides a retention aid composition, wherein the retention aid composition comprises an unmodified silica and a buffer (e.g., boric acid).

In some aspects, the present disclosure provides a retention aid composition, wherein the retention aid composition comprises a modified silica and a buffer (e.g., boric acid).

In some aspects, the present disclosure provides a batch process for preparing silica comprising:
mixing a retention aid, an acid, and a buffer in a reaction tank, the mixture having a pH of about 9 to about 9.5;
aging the mixture in the reaction tank for a period of time sufficient for the turbidity to reach about 10 NTU to about 50 NTU and the solid content in the mixture is about 2 wt. % to about 6 wt. %; and
transferring the mixture to a vessel (e.g., a day tank) and diluting the mixture with water to a silica concentration of about 0.1 wt. % to about 3 wt. %.

In some aspects, the present disclosure provides a retention aid composition, wherein the retention aid composition comprises an unmodified silica, acid, and buffer in reaction tank, wherein the unmodified silica has an S-value of about 3 to about 20.

In some aspects, the present disclosure provides a retention aid composition, wherein the retention aid composition comprises a modified silica, an acid, a buffer, and an aluminate salt, wherein the modified silica has a S-value of about 2 to about 15.

In some aspects, the present disclosure provides a process for preparing silica, comprising adding a silicate to water to form a first mixture; adding an acid to the first mixture to form a second mixture; mixing the second mixture to produce silica until a predetermined turbidity value and/or a predetermined pH value has been achieved; and adding a termination water to the second mixture when the predetermined turbidity value and/or the predetermined pH value has been achieved to form a third mixture, wherein the third mixture has a silica concentration of about 0.1 wt. % to about 5 wt. %.

In some aspects, the present disclosure provides a process for preparing silica, comprising adding a silicate to water to form a first mixture; adding an acid to the first mixture to form a second mixture, wherein the second mixture comprises a pH of about 8 to about 11; mixing the second mixture to produce silica until a predetermined turbidity value and/or a predetermined pH value has been achieved; and adding a termination water to the second mixture when the predetermined turbidity value and/or the predetermined pH value has been achieved to form a third mixture, wherein the third mixture has a silica concentration of about 0.1 wt. % to about 5 wt. % and a pH value of about 9 to about 12.

In some aspects, the present disclosure provides a silica composition prepared by: adding a silicate to water to form a first mixture; adding an acid to the first mixture to form a second mixture, wherein the second mixture comprises a pH of about 8 to about 11; mixing the second mixture to produce silica until a predetermined turbidity value and/or a predetermined pH value has been achieved; and adding a termination water to the second mixture when the predetermined turbidity value and/or the predetermined pH value has been achieved to form a third mixture, wherein the third mixture has a silica concentration of about 0.1 wt. % to about 5 wt. % and a pH value of about 9 to about 12.

In some aspects, the present disclosure provides a method of improving drainage in a papermaking process comprising adding a silica composition disclosed herein to a papermaking furnish.

### BRIEF DESCRIPTION OF THE SEVERAL VIEWS OF THE DRAWINGS

A detailed description of the invention is hereafter described with specific reference being made to the drawings in which:

FIG. 1 shows a schematic of a batch process method for on-site silica generation.

FIG. 2 is a scatter plot of gel time(s) vs. pH.

FIG. 3 shows a pH curve of on-site silica generation (buffered vs. unbuffered).

FIG. 4 shows turbidity and S-value vs. reaction time.

FIG. 5 shows viscosity vs. reaction time.

FIG. 6 shows a white water turbidity reduction response.

FIG. 7 is a drainage comparison between samples and the N9000 benchmark.

FIG. 8 shows the results of aluminum modified and unmodified silica charge density measurements under pH 5.2.

FIG. 9 shows the drainage percent improvement of modified silica over the N9000 benchmark.

FIG. 10 shows the retention percent improvement of modified silica over the N9000 benchmark.

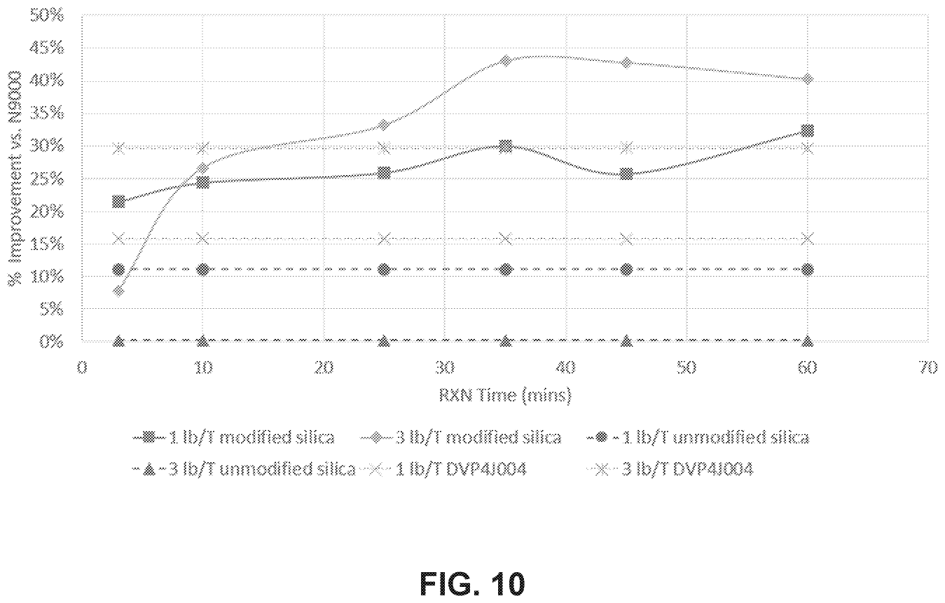

FIG. 11A is an on-site silica particle and structure image.

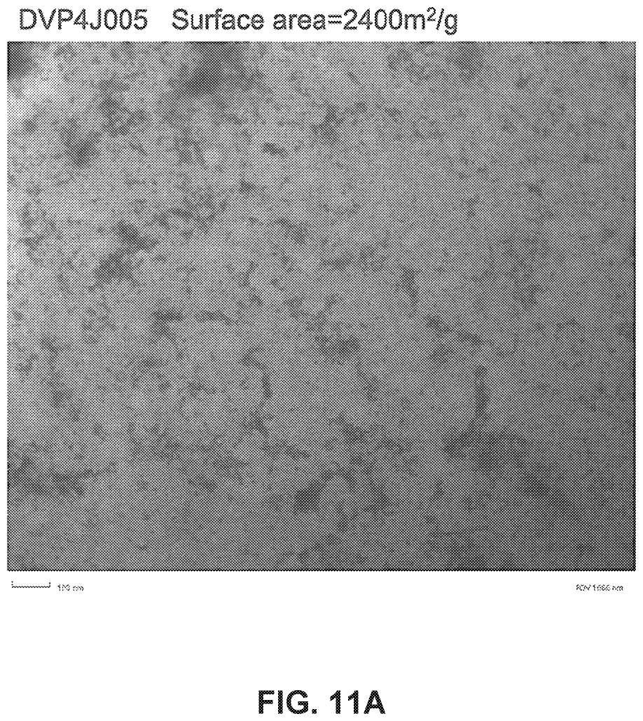

FIG. 11B shows benchmark N9000 particle and structure images.

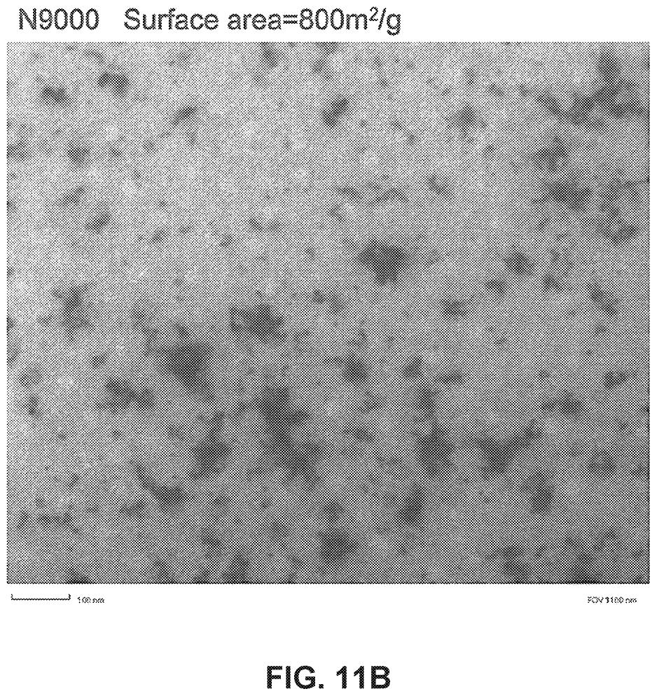

FIG. 12 shows results of the on-site silica dilution ratio optimization based on performance stability.

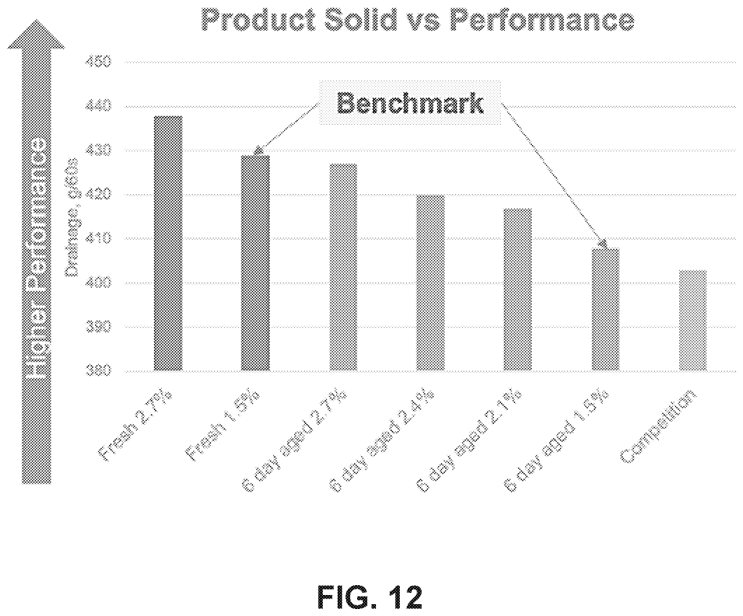

FIG. 13 shows a reaction progression graph. 0 minutes (min) indicates the start of acid addition into the water glass and heel water (i.e., the water added to the reaction tank as solvent before the initiation of the reaction) mixture—a sharp drop is shown. As the reaction continued, turbidity increased linearly, and the pH slightly increased. After termination water was added in five stages at 40 min, the pH continued to slightly increase and the conductivity dropped.

FIG. 14 shows the results of drainage performance testing for silica products at a dosage of 0.75 kpt. The y-axis is drainage rate (g/60 s) and the x-axis is product SiO₂ wt. %. The tested silica products had a pH of 10.8 (fresh (i.e., substantially no aging)), 10.5 (fresh), 10.8 (aged for 6 days), and 10.5 (aged for 6 days).

FIG. 15 shows the results of shelf life testing at 25 °C for a silica product having a pH of 10.9. The y-axis is shelf life (days) and the x-axis is product SiO₂ wt. %.

### DETAILED DESCRIPTION

Various embodiments are described below. The relationship and functioning of the various elements of the embodiments will be better understood in light of the following detailed description. However, elements and embodiments are not strictly limited to those explicitly described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

“On-site” refers to the location where the silica will be used, such as a paper mill. Accordingly, as disclosed herein an on-site batch process for the preparation of silica refers to instances where the silica is prepared and consumed in the same or in a nearby location. For example, the silica may be prepared at the same location or nearby vicinity of the paper mill where the silica will be used in the papermaking process.

The terms “retention aid composition”, “retention agent”, and “retention aid” refer to a composition comprising an unmodified silica or a modified silica prepared, for example, according to methods disclosed herein and, optionally, a buffer (e.g., boric acid).

“S-value” refers to the measurement of the degree of aggregation of colloidal materials (such as silica).

Additional details regarding S-values may be found in The Chemistry of Silica: Solubility, Polymerization, Colloid and Surface Properties and Biochemistry of Silica, by Ralph K. Iler, John Wiley and Sons, Inc., (1979); which is incorporated herein by reference in its entirety.

“Capacity level” refers to the molar ratio of the buffer molar concentration to the total acid molar concentration. It is understood that the capacity level may be expressed as a percentage.

“Unmodified silica” refers to a silica (e.g., a silica particle) that consists essentially of silicon dioxide (SiO₂).

The present disclosure provides advantages such as methods for generating silica on-site using batch process methods. The methods disclosed herein advantageously provide processes for on-site silica preparation with enhanced stability, reduced costs, and may expand the silica application to regions with high temperatures (for example, by way of the enhanced shelf life of the produced silica). In some embodiments, a method disclosed herein results in stable product performance. In some embodiments, a method disclosed herein provides the surface modification of silica to facilitate the preparation of, e.g., aluminum modified silica on-site. One advantage of the present disclosure is that it provides improved batch processes for preparing silica that overcome the challenges of using batch processes on a commercial scale.

One advantage of the present disclosure is that it may provide silica with an about 15% performance improvement on an active basis compared to conventional silica.

One advantage of the present disclosure is that it may provide stable processes that are tolerant to raw material perturbation as well as stable product (silica product) performance (including over time) with a shelf-life of about 2 months or more.

In some embodiments, a papermaking process described herein refers to any portion of a method of making paper products from pulp comprising forming an aqueous cellulosic papermaking furnish, draining the furnish to form a sheet and drying the sheet. The steps of forming the papermaking furnish, draining and drying may be carried out in any conventional manner generally known to those skilled in the art. The papermaking process may also include a pulping stage, i.e. making pulp from a lignocellulosic raw material and bleaching stage, i.e. chemical treatment of the pulp for brightness improvement, papermaking is further described in the reference Handbook for Pulp and Paper Technologists, 3rd Edition, by Gary A. Smook, Angus Wilde Publications Inc., (2002) and The Nalco Water Handbook (3rd Edition), by Daniel Flynn, McGraw Hill (2009) in general and in particular pp. 32.1-32.44. It is understood that papermaking processes include methods of making paper products from pulp comprising forming an aqueous cellulosic papermaking furnish, draining the furnish to form a sheet and drying the sheet. The steps of forming the papermaking furnish, draining and drying may be carried out in any conventional manner generally known to those skilled in the art. Conventional microparticles, alum, cationic starch or a combination thereof may be utilized as adjuncts with the polymer treatment of this invention, though it must be emphasized that no adjunct is required for effective dewatering activity.

A paper product described herein may refer, for example, to the end product of a papermaking process, such as writing paper, printer paper, tissue paper, cardboard, paperboard, packaging paper, or any combination thereof.

It is understood that, during papermaking processes, a retention aid or retention aid system comprising one more components may be added to a pulp/filler suspension in the furnish to retain the filler in the resulting paper sheet. Retention aids are typically used to improve retention fine of particles and fillers during the formation of paper. They can also be used to improve the retention of other papermaking chemicals, including sizing and cationic starches.

In some embodiments, a batch process for preparing silica described herein comprises preparing silica in batching. For example, a batch process for preparing silica may include terminating the production of silica (i.e., gel formation) after a desired parameter is achieved, such as turbidity, S-value, etc. In some embodiments, a batch process for preparing silica described herein comprises:
mixing a silicate salt, an acid, and a buffer, and water in a vessel (to obtain a mixture, wherein the mixture has a pH of about 8.5 to about 10 or about 9 to about 9.5;
aging the mixture for a period of time sufficient to obtain a desired turbidity to obtain an unmodified silica, wherein the unmodified silica has a S-value of about 2 to about 10; and
diluting the mixture with water to obtain silica with a concentration of about 0.1 wt. % to about 3 wt. %, or about 2.4 wt. % to about 2.6 wt. %.

In some embodiments, a turbidity value described herein is determined by measuring the level of gel formation during silica preparation. For example, the turbidity may be measured using a conventional turbidimeter, such as SURFACE SCATTER 7SC turbidimeter, a continuous-monitoring instrument designed for measuring turbidity in fluids. The instrument design is based on the nephelometric principle, in which light scattered by particles suspended in the fluid is measured to determine the relative amount of particulate matter in the fluid.

The batch processing of silica disclosed herein may be performed on-site in the present disclosure, namely at (or near) the location where the silica will be used, such as a paper mill. It is understood that on-site generation may be more cost effective due to the reduced shipping and packaging costs and overhead costs. Additionally, on-site silica generation may ease the manufacturing capacity pressure. It is understood that there is also substantially no shelf-life concern with this approach. In some embodiments, the generated silica has a potential active performance gain of about 15% improvement.

In some embodiments, a retention aid composition comprising sodium silicate, an acid (inorganic or organic), and a buffer are added to a reaction tank within a desired ratio. The pH, viscosity and/or turbidity may be monitored during the reaction. Once the turbidity reaches the control limit/predetermined value, the solution may be pumped out of the reaction tank and diluted with extra water. The dilution using water may effectively stop further reaction (i.e., terminate the reaction). In some embodiments, an aluminum source is added together with the dilution water to modify the surface of a silica particle.

In some embodiments, a retention aid composition described herein comprises a modified silica, an inorganic acid, a buffer, and an aluminate salt, wherein the modified silica has a S-value of about 2 to about 15, such as about 5 to about 15, about 10 to about 15, about 2 to about 10, or about 2 to about 5. In some embodiments, a retention aid composition described herein comprises a modified silica, a buffer comprising an acid, and an aluminate salt; wherein the modified silica has a S-value of about 2 to about 15, such as about 5 to about 15, about 10 to about 15, about 2 to about 10, or about 2 to about 5. In some embodiments, the retention aid composition comprises an unmodified silica, an inorganic acid, and buffer in reaction tank; wherein the unmodified silica has an S-value of about 3 to about 20, such as about 5 to about 20, about 10 to about 20, about 15 to about 20, about 3 to about 15, or about 3 to about 10. In some embodiments, the retention aid composition comprises an unmodified silica, acid, and buffer in reaction tank; wherein the unmodified silica has an S-value of about 3 to about 20, such as about 5 to about 20, about 10 to about 20, about 15 to about 20, about 3 to about 15, or about 3 to about 10. In some embodiments, the retention aid composition comprises an unmodified silica and a buffer comprising an acid in reaction tank; wherein the unmodified silica has an S-value of about 3 to about 20, such as about 5 to about 20, about 10 to about 20, about 15 to about 20, about 3 to about 15, or about 3 to about 10.

A silica described herein may comprise colloidal silica.

In some embodiments, an unmodified silica disclosed herein has an S-value of about 3 to about 20, turbidity of about 10 NTU to about 40 NTU, solid content in the reaction of about 2 wt. % to about 6 wt. %, a viscosity of about 50 cPs or less, and an average particle size of about 0.5 nm to about 6 nm, about 1 nm to about 3 nm, about 1 nm to about 2 nm, or about 1 nm to about 1.5 nm.

In some embodiments, a modified silica described herein comprises the partial replacement of silicon atoms with other elements such as boron and/or aluminum.

In some embodiments, a modified silica described herein is modified in a homogenous manner (i.e., a replacement atom such as aluminum is homogeneously distributed throughout the silica particle).

In some embodiments, a modified silica described herein is surface-modified (i.e., a replacement atom such as aluminum is substantially located on the surface of the particle).

It is understood that the reaction between silicate salt and acid and particle growth may be very quick (such as on a timescale of seconds). The speed of the reaction may be a function of pH, conductivity, and/or the concentration of the reactants.

In some embodiments, a silica described herein is prepared on-site in a batch, (e.g., a semi-batch, or a full batch).

In some embodiments, a period of time described herein (e.g., for the aging of a mixture) is about 5 minutes to about 60 minutes or about 20 minutes to about 40 minutes.

In some embodiments, a mixture described (e.g., a second mixture) herein has a pH of about 7 to about 11, such as about 7 to about 9, about 8.5 to about 10, about 8 to about 11, or about 8 to about 10.9. In some embodiments, the pH is about 7.0, about 7.2, about 7.4, about 7.6, about 7.8, about 8.0, about 8.2, about 8.4, about 8.6, about 8.8, about 9.0, about 9.2, about 9.4, about 9.6, about 9.8, about 10.0, about 10.2, about 10.4, about 10.6, about 10.8, or about 11.0. In some embodiments, a mixture described (e.g., a third mixture) herein has a pH of about 9 to about 12, such as about 9 to about 11, about 9 to about 10.5, about 10 to about 12, or about 10.5 to about 12.

A predetermined pH value described herein may be from about 9 to about 12, such as about 9 to about 11, about 9 to about 10.5, about 10 to about 12, about 10.5 to about 12, about 9.5 to about 12.0, or about 10.0 to about 11.8. In some embodiments, the predetermined pH is about 9.2, about 9.4, about 9.6, about 9.8, about 10.0, about 10.2, about 10.4, about 10.6, about 10.8, or about 11.0.

In some embodiments, a dilution of a mixture described herein comprises a ratio of water to silica of about 1:1 to about 100:1, or about 3:1.

A turbidity described herein (e.g., a predetermined turbidity value) may be from about 10 NTU to about 50 NTU, such as about 20 NTU to about 40 NTU, about 20 NTU, about 25 NTU, about 30 NTU, about 35 NTU, about 40 NTU, or about 45 NTU. In some embodiments, a mixture described herein has turbidity of about 10 NTU to about 40 NTU. In some embodiments, a mixture described herein has turbidity of about 10 NTU to about 40 NTU after aging.

In some embodiments, a mixture described herein has a solid content in the reaction of about 2 wt. % to about 6 wt. %. In some embodiments, a mixture described herein has a solid content in the reaction of about 2 wt. % to about 6 wt. % after aging. In some embodiments, a mixture described herein has a solid content in the reaction of about 3 wt. %.

In some embodiments, a mixture described herein has a viscosity of about 50 cPs or less. In some embodiments, a mixture described herein has a viscosity of about 50 cPs or less after aging.

In some embodiments, an unmodified silica described herein has an average particle size of about 2 nm to about 6 nm.

A silica described herein (e.g., a silica present in a third mixture) may have an S-value of about 2 to about 25, such as about 5 to about 25, about 10 to about 25, about 15 to about 25, about 20 to about 25, about 21 to about 25, about 22 to about 25, or about 23 to about 25. In some embodiments, a silica described herein has an S-value of about 2 to about 10. In some embodiments, an unmodified silica described herein has an S-value of about 4 to about 10.

In some embodiments, an unmodified silica described herein comprises a particle with a surface area of about 500 m²/g to about 6000 m²/g, or about 2000 m²/g to about 3000 m²/g.

A silicate salt described herein may comprise, for example, sodium silicate, calcium silicate, ammonium silicate, potassium silicate, or any combination thereof.

A water described herein may comprise, for example, tap water, soft water, deionized water, clarified white water, steam condensate water, or any combination thereof. In some embodiments, a termination water described herein comprises tap water, soft water, deionized water, clarified white water, steam condensate water, or any combination thereof.

A mixture described herein may have a conductivity of about 3,000 μS/cm to about 6,000 μS/cm per 1% SiO₂, such as about 3,500 μS/cm to about 6,000 μS/cm, about 4,000 μS/cm to about 6,000 μS/cm, about 4,500 μS/cm to about 6,000 μS/cm, about 3,000 μS/cm to about 5,500 μS/cm, about 3,000 μS/cm to about 5,000 μS/cm, or about 3,000 μS/cm to about 4,000 μS/cm per 1% SiO₂, as measured using a conductivity meter. In some embodiments, a mixture described herein has a conductivity of about 3,000 μS/cm to about 6,000 μS/cm per 1% SiO₂, such as about 3,500 μS/cm to about 6,000 μS/cm, about 4,000 μS/cm to about 6,000 μS/cm, about 4,500 μS/cm to about 6,000 μS/cm, about 3,000 μS/cm to about 5,500 μS/cm, about 3,000 μS/cm to about 5,000 μS/cm, or about 3,000 μS/cm to about 4,000 μS/cm per 1% SiO₂, as measured according to ISO 7888:1985.

An acid described herein may comprise an organic acid or an inorganic acid (e.g., a strong inorganic acid). In some embodiments, the acid comprises an organic acid. In some embodiments, the acid comprises an inorganic acid. In some embodiments, an acid described herein comprises citric acid, butanetetracarboxylic acid, cyclopentane tetracarboxylic acid, malic acid, succinic acid, polyacrylic acid, nitric acid, hydrochloric acid, sulfuric acid, or any combination thereof. In some embodiments, an acid described herein comprises formic acid, acetic acid, itaconic acid, citric acid, butanetetracarboxylic acid, cyclopentane tetracarboxylic acid, malic acid, succinic acid, acrylic acid, polyacrylic acid, or any combination thereof. In some embodiments, an acid described herein comprises sulfamic acid, nitric acid, hydrochloric acid, sulfuric acid, or any combination thereof. In some embodiments, an acid described herein comprises formic acid, acetic acid, itaconic acid, citric acid, butanetetracarboxylic acid, cyclopentane tetracarboxylic acid, malic acid, succinic acid, acrylic acid, polyacrylic acid, sulfamic acid, nitric acid, hydrochloric acid, sulfuric acid, or any combination thereof.

In some embodiments, an acid described herein comprises citric acid monohydrate.

In some embodiments, an acid described herein is added to a mixture as a solid. In some embodiments, an acid described herein is added to a mixture as a solution. In some embodiments, an acid described herein is added to a mixture as a solution, wherein the solvent comprises water.

When an acid described herein is added to a mixture as a solution, the concentration of the acid (e.g., citric acid monohydrate) is not particularly limited. For example, the solution may include about 1 wt. % to about 99 wt. % of the acid, such as about 10 wt. % to about 95 wt. %, about 15 wt. % to about 90 wt. %, about 20 wt. % to about 80 wt. %, about 30 wt. % to about 60 wt. %, about 20 wt. % to about 60 wt. %, or about 10 wt. % to about 50 wt. %. In some embodiments, the solution includes about 10 wt. %, about 20 wt. %, about 30 wt. %, about 40 wt. %, or about 50 wt. % of the acid.

In some embodiments, an acid is added to a mixture described herein with a starting pH of about 7 to about 10, such as about 8.5 to about 10, about 8 to 10, or about 9 to 10. In some embodiments, the starting pH is about 7.0, about 7.2, about 7.4, about 7.6, about 7.8, about 8.0, about 8.2, about 8.4, about 8.6, about 8.8, about 9.0, about 9.2, about 9.4, about 9.6, about 9.8, or about 10.0.

The pH of a first mixture described herein (sometimes called a starting pH) may be about 8.5 to about 11.0, such as about 8.5 to about 10.0, or about 9.0 to about 10.8. In some embodiments, the pH of the first mixture is about 8.5, about 9.0, about 9.5, about 10, or about 10.5.

A termination pH described herein (i.e., a pH of a mixture after a termination water has been added) may be about 9.0 to about 11.5, such as about 8.5 to about 10.0, about 9 to about 11.5, or about 9.5 to about 11.0.

In some embodiments, a buffer described herein has a capacity level of about 0% to about 50%. In some embodiments, a buffer described herein has a capacity level of about 10%.

A buffer described herein may comprise a solution that substantially resists changes in pH upon dilution and/or if an acid or a base is added to the solution at constant temperature. A buffer described herein may comprise an acid described herein. Exemplary buffers and/or buffering agents include, but are not limited to, citrate buffer solutions, acetate buffer solutions, phosphate buffer solutions, ammonium chloride, calcium carbonate, calcium chloride, calcium citrate, calcium glycerophosphate, calcium lactate, propanoic acid, calcium levulinate, pentanoic acid, dibasic calcium phosphate, phosphoric acid, tribasic calcium phosphate, calcium hydroxide phosphate, potassium acetate, potassium chloride, potassium gluconate, potassium mixtures, dibasic potassium phosphate, monobasic potassium phosphate, potassium phosphate mixtures, sodium acetate, sodium bicarbonate, sodium chloride, sodium citrate, sodium lactate, dibasic sodium phosphate, monobasic sodium phosphate, sodium phosphate mixtures, tromethamine, magnesium hydroxide, aluminum hydroxide, ammonium hydroxide, tris(hydroxymethyl)aminomethane (Tris), and boric acid. A buffer described herein may comprise a solvent such as water. In some embodiments, a buffer described herein comprises boric acid, a carbonate, ammonium hydroxide, Tris, or any combination thereof. In some embodiments, a buffer described herein comprises boric acid.

In some embodiments, a buffer described herein is present in a composition/method described herein at a concentration of about 0 wt. % to about 50 wt. %.

A mixture described herein (e.g., a third mixture) may have a silica concentration of about 0.1 wt. % to about 5 wt. %, such as about 1.5 wt. % to about 5 wt. %, about 1.5 wt. % to about 2.8 wt. %, about 2.0 wt. % to about 5 wt. %, about 2.4 wt. % to about 5 wt. %, about 2.4 wt. % to about 3.4 wt. %, about 3.1 wt. % to about 5 wt. %, about 0.5 wt. % to about 3.5 wt. %, about 3.5 wt. %, about 4.0 wt. %, about 4.5 wt. %, or about 5.0 wt. %.

A mixture described herein (e.g., a third mixture) may have a silica concentration of about 0.1 wt. % to about 5 wt. % and a pH of about 9 to about 12, a silica concentration of about 1 wt. % to about 5 wt. % and a pH of about 9 to about 12, a silica concentration of about 1 wt. % to about 3 wt. % and a pH of about 9 to about 12, a silica concentration of about 2 wt. % to about 4 wt. % and a pH of about 9 to about 12, a silica concentration of about 0.1 wt. % to about 5 wt. % and a pH of about 10.0 to about 11.0, a silica concentration of about 2 wt. % to about 4 wt. % and a pH of about 10.0 to about 11.0, a silica concentration of about 2 wt. % to about 4 wt. % and a pH of about 10.8, or a silica concentration of about 0.5 wt. % to about 3.5 wt. % and a pH of about 9.0 to about 10.8.

A silica composition disclosed herein may comprise a silica present at a concentration of about 0.1 wt. % to about 5 wt. %, such as about 1.5 wt. % to about 5 wt. %, about 1.5 wt. % to about 2.8 wt. %, about 2.0 wt. % to about 5 wt. %, about 2.4 wt. % to about 5 wt. %, about 2.4 wt. % to about 3.4 wt. %, about 3.1 wt. % to about 5 wt. %, about 0.5 wt. % to about 3.5 wt. %, about 3.5 wt. %, about 4.0 wt. %, about 4.5 wt. %, or about 5.0 wt. %.

A silica composition disclosed herein may comprise a silica present at a concentration of about 0.1 wt. % to about 5 wt. % and a pH of about 9 to about 12, a silica present at a concentration of about 1 wt. % to about 5 wt. % and a pH of about 9 to about 12, a silica present at a concentration of about 1 wt. % to about 3 wt. % and a pH of about 9 to about 12, a silica present at a concentration of about 2 wt. % to about 4 wt. % and a pH of about 9 to about 12, a silica present at a concentration of about 0.1 wt. % to about 5 wt. % and a pH of about 10.0 to about 11.0, a silica present at a concentration of about 2 wt. % to about 4 wt. % and a pH of about 10.0 to about 11.0, a silica present at a concentration of about 2 wt. % to about 4 wt. % and a pH of about 10.8, or a silica concentration of about 0.5 wt. % to about 3.5 wt. % and a pH of about 9.0 to about 10.8.

In some embodiments, an aluminate salt described herein comprises sodium aluminate, potassium aluminate, calcium aluminate, or any combination thereof.

In some embodiments, an aluminate salt described herein is present in a composition/method described herein at a concentration of about 0.2 mol/L or less or about 0.04 mol/L or less.

In some embodiments, an aluminate salt described herein and a silica described herein are present in a composition/method described herein at a molar ratio of about 0.02 to about 0.30 or about 0.05 to about 0.07.

A silica composition disclosed herein may be substantially free of a gel for a period of time. For example, the period of time may be about two weeks or more, about one month or more, about two months or more, or about three months or more. In some embodiments, a silica composition disclosed herein is free from a gel for at least about 60 days.

In some embodiments, a silica composition disclosed herein has a gel time of at least about 5 minutes, at least about 10 minutes, at least about 15 minutes, at least about 20 minutes, at least about 25 minutes, at least about 30 minutes, at least about 35 minutes, at least about 40 minutes, at least about 45 minutes, at least about 50 minutes, or at least about 55 minutes.

A silica composition disclosed herein provides a drainage rate of about 400 g/60 s to about 450 g/60 s, such as about 410 g/60 s to about 440 g/60 s. In some embodiments, the drainage rate is about 400 g/60 s or more, about 410 g/60 s or more, about 420 g/60 s or more, about 430 g/60 s or more, or about 440 g/60 s or more.

A method disclosed herein may comprise measuring a pH. For example, the method may comprise measuring the pH of a mixture described herein (e.g., a first mixture or a second mixture). In some embodiments, the pH is measured after adding a silicate described herein to a water described herein to form a first mixture. In some embodiments, the pH is measured after adding an acid to the first mixture to form a second mixture. The period of time for measuring the pH is not particularly limited. For example, the period of time may be about 1 minute, about 2 minutes, about 3 minutes, about 4 minutes, about 5 minutes, about 6 minutes, about 7 minutes, about 8 minutes, about 9 minutes, about 10 minutes, about 15 minutes, about 20 minutes, about 25 minutes, or about 30 minutes.

A method disclosed herein may comprise adding a termination water to a second mixture at a dilution ratio of termination water to silica of about 0.1:1 to about 2:1, such as about 0.2:1, about 0.3:1, about 0.4:1, about 0.5:1, about 0.6:1, about 0.7:1, about 0.8:1, about 0.9:1, about 1:1, about 1.1:1, about 1.2:1, about 1.3:1, about 1.4:1, about 1.5:1, about 1.6:1, about 1.7:1, about 1.8:1, about 1.9:1, or about 2:1. In some embodiments, a method disclosed herein comprises adding a termination water to a second mixture at a dilution ratio of termination water to silica of about 0.4:1 to about 0.8:1.

The compositions, compounds, and/or components disclosed herein may be added in a method disclosed herein using a variety of different application methods. In some embodiments, the compositions, compounds, and/or components may be added continuously or intermittently to the medium, either automatically or manually, by using, for example, chemical injection pumps. The addition may involve dripping, pouring, spraying, pumping, injecting, or otherwise adding the composition, compound, and/or optional component to, e.g., a mixture described herein. In certain embodiments, a compound, composition, and/or component may be introduced into the mixture by any conventional method, such as manually or automatically using a chemical injection pump, and are fed into the mixture on either a periodic or continuous basis. In certain embodiments, a compound, composition, and/or component may be introduced into a vessel (e.g., a reaction tank) by any conventional method, such as manually or automatically using a chemical injection pump, and are fed into the vessel on either a periodic or continuous basis.

A termination water described herein may be added continuously or intermittently. A termination water described herein may be added in a single portion or added in a plurality of portions. In some embodiments, a termination water described herein is added in about 1 to about 10 portions, such as about 5 portions.

A method disclosed herein may comprise adding an aluminate salt, an aluminum salt, or a combination thereof, to the third mixture to form a modified silica.

A method disclosed herein may comprise storing a silica composition for a period of time before adding it to the papermaking furnish. The period of time may be, for example, about seven days or more, about eight days or more, about nine days or more, about ten days or more, about two weeks or more, or about a month or more. In some embodiments, a method disclosed herein comprises storing the silica composition for at least about seven days before adding it to the papermaking furnish.

A water glass described herein may comprise a metal silicate salt (e.g. sodium silicate, calcium silicate, ammonium silicate or potassium silicate). In some embodiments, the water glass comprises sodium silicate, wherein the sodium silicate is Na₂O·nSiO₂, further wherein n is from about 1.5 to about 3.5. In some embodiments, the density of the sodium silicate is between about 1.3 g/cm³ and about 1.70 g/cm³.

A heel water described herein may comprise, for example, tap water, soft water, deionized water, clarified white water, steam condensate water, or any combination thereof.

A method disclosed herein may comprise or exclude adding a buffer to the first mixture, the second mixture, and/or the third mixture.

Various examples of embodiments of the present disclosure are provided below. It will be recognized that features specified in each embodiment may be combined with other specified features from other embodiments to provide further embodiments of the present disclosure.

Embodiment 1. A batch process for preparing silica, comprising:
a) mixing a silicate salt in the range of about 26% to about 29%, an acid, and a buffer, and water in a vessel to obtain a mixture, wherein the mixture has a pH of about 8.5 to about 10;
b) aging the mixture for a period of time sufficient to obtain a turbidity in the range of about 10 NTU to about 50 NTU; to obtain unmodified silica, wherein the unmodified silica has a S-value of about 2 to about 10 or about 4 to about 10, and
c) diluting the mixture with water to obtain silica with a concentration of about 0.1 wt. % to about 3 wt. %, or about 2.4 wt. % to about 2.6 wt. %.

Embodiment 2. The process of Embodiment 1, wherein the silicate salt comprises sodium silicate, calcium silicate, ammonium silicate, potassium silicate, or any combination thereof.

Embodiment 3. The process of Embodiment 1 or Embodiment 2, wherein the buffer comprises boric acid, a carbonate, ammonium hydroxide, Tris buffer, or any combination thereof.

Embodiment 4. The process of any one of Embodiments 1 to 3, wherein the vessel comprises a reaction tank.

Embodiment 5. The process of any one of Embodiments 1 to 4, wherein the pH is about 9 to about 9.5.

Embodiment 6. The process of any of Embodiments 1 to 5, wherein the mixture of step (b) is aged for about 5 minutes to about 60 minutes.

Embodiment 7. The process of any one of Embodiments 1 to 6, wherein the mixture of step (b) is aged for about 20 minutes to about 40 minutes.

Embodiment 8. The process of any one of Embodiments 1 to 7, wherein the mixture of step (b) has a pH in the range of about 9 to about 10.5.

Embodiment 9. The process of any one of Embodiments 1 to 8, wherein the dilution of step (c) is in a dilution ratio of about 0.1:1 to about 100:1 (water:silica).

Embodiment 10. The process of any one of Embodiments 1 to 9, wherein the dilution of step (c) is in a dilution ratio of about 3:1.

Embodiment 11. The process of any one of Embodiments 1 to 10, wherein the unmodified silica particles have a surface area of about 500 m²/g to about 6000 m²/g, or about 2000 m²/g to about 3000 m²/g.

Embodiment 12. The process of any one of Embodiments 1 to 11, wherein the acid is an inorganic or organic acid.

Embodiment 13. The process of any one of Embodiments 1 to 12, wherein the acid is citric acid, butanetetracarboxylic acid, cyclopentane tetracarboxylic acid, malic acid, succinic acid, polyacrylic acid, nitric acid, hydrochloric acid, or sulfuric acid.

Embodiment 14. The process of any one of Embodiments 1 to 13, wherein the buffer has a capacity level of about 0% to about 50%.

Embodiment 15. The process of any one of Embodiments 1 to 14, wherein the buffer has a capacity level of about 10% to about 20%.

Embodiment 16. The process of any one of Embodiments 1 to 15, wherein the buffer is boric acid, carbonate buffer (such as sodium bicarbonate and/or calcium carbonate), ammonium hydroxide, or Tris buffer.

Embodiment 17. The process of any one of Embodiments 1 to 16, the process further comprising adding an aluminate salt (such as sodium aluminate) to the water of step (c) to obtain modified silica, wherein the modified silica has an aluminate surface modification molar ratio in the range of about 0.02 to about 0.3 or about 0.05 to about 0.07 (Al:Si).

Embodiment 18. The process of any one of Embodiments 1 to 17, wherein the aluminum salt is sodium aluminate, potassium aluminate or calcium aluminate.

Embodiment 19. The process of Embodiment 17 or Embodiment 18, wherein the aluminate salt has a concentration less than about 0.2 mol/L.

Embodiment 20. The process of any one of Embodiments 17 to 19, wherein the aluminate salt has a concentration of less than about 0.04 mol/L.

Embodiment 21. The process of any one of Embodiments 17 to 20, wherein the sodium aluminate and silica is present in a molar ratio in the range of about 0.02 to about 0.30.

Embodiment 22. The process of any one of Embodiments 17 to 21, wherein the sodium aluminate and silica is present in a molar ratio in the range of about 0.05 to about 0.07.

Embodiment 23. The process of any one Embodiments 1 to 22, wherein the silica is prepared on-site.

Embodiment 24. An unmodified silica prepared according to a method of any one of Embodiments 1 to 23.

Embodiment 25. A modified silica prepared according to a method of any one of Embodiments 1 to 23.

Embodiment 26. A retention aid composition, comprising unmodified silica according to Embodiment 24 and a buffer (e.g. boric acid) in the range of about 0% to about 50%.

Embodiment 27. A retention aid composition, comprising modified silica according to Embodiment 25 and a buffer (e.g. boric acid) in the range of about 0% to about 50%.

Embodiment 28. A method for enhancing paper strength and press section dewatering of a paper sheet on a paper machine comprising adding to the paper sheet about 0.05 lb/ton (about 0.025 kg/tonne) to about 20 lb/ton (about 10 kg/tonne) dry silica.

Embodiment 29. A method for enhancing paper strength of a paper sheet on a paper machine comprising adding to the paper sheet about 0.05 lb/ton (about 0.025 kg/tonne) to about 20 lb/ton (about 10 kg/tonne), based on dry fiber, of the silica of Embodiment 24 or Embodiment 25.

Embodiment 30. The process of any one of Embodiments 1 to 23, wherein the silica is prepared on-site in a semi-batch or a full batch.

Embodiment 31. The process of any one of Embodiments 1 to 23, wherein the silicate salt is sodium silicate, calcium silicate, ammonium silicate or potassium silicate.

The foregoing may be better understood by reference to the following examples, which are presented for purposes of illustration and are not intended to limit the scope of the invention.

### EXAMPLES

### Example 1. Batch Processing Method for the Generation of Silica

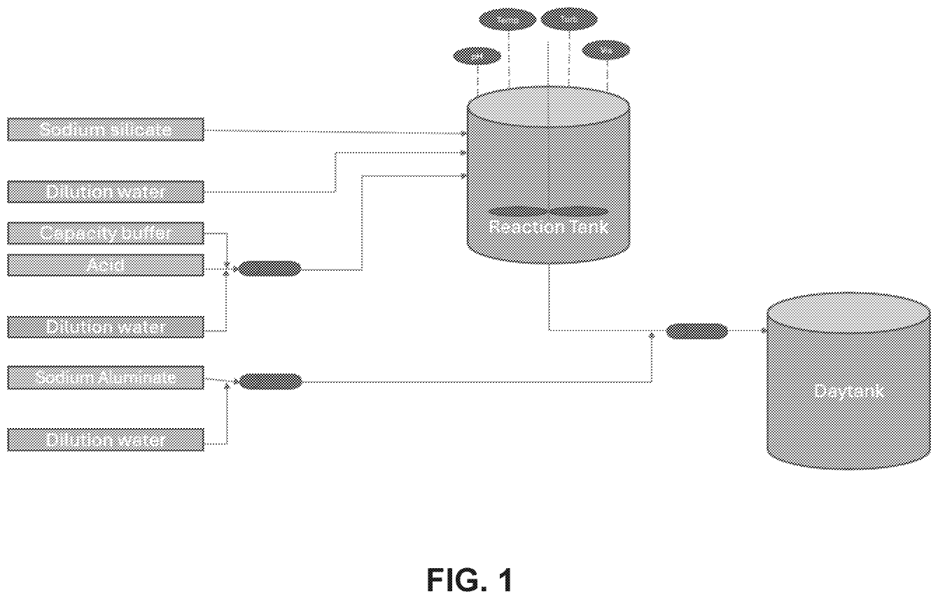

A batch process will be employed for the reaction (FIG. 1). Sodium silicate and acids are added to the reaction tank with designed ratio. The pH, viscosity and turbidity will be monitored during the reaction. Once the turbidity reaches the control limit, the solution will be pumped out of the reaction tank and diluted with extra water. The dilution can effectively stop further reaction. Aluminum source can be added together with dilution water to modify the surface of silica particle. Batch reaction results are in Table 1.

TABLE 1
Results from batch process generation of silica on-site

| Silicate solution | | Acid solution | | Silicate | SiO2 solid | | |
|---|---|---|---|---|---|---|---|
| Dilution | | Dilution | | to acid | contend | Starting | Gel time |
| Water (g) | R-50599 (g) | Water (g) | H2SO4 (g) | ratio (g/g) | in reaction | pH | (min) |
| 437 | 107 | 530 | 12.48 | 8.57 | 2.76% | 8.22 | 2 |
| 437 | 107 | 530 | 11.48 | 9.32 | 2.76% | 9.45 | >30 |
| 437 | 107 | 530 | 12 | 8.92 | 2.76% | 8.94 | 10 |
| 437 | 107 | 530 | 12.25 | 8.73 | 2.76% | 8.98 | 8 |
| 437 | 107 | 530 | 11.75 | 9.11 | 2.76% | 9.16 | 40 |
| 437 | 500 | 530 | 54.9 | 9.11 | 9.20% | N/A | Instantly |
| 43.7 | 50 | 53 | 4.67 | 10.71 | 9.25% | N/A | Instantly |
| 80 | 20 | 97.2 | 2.8 | 7.14 | 2.80% | 6.96 | 2.5 |
| 80 | 20 | 97.4 | 2.6 | 7.69 | 2.80% | 5.68 | 23 |
| 80 | 20 | 97.6 | 2.4 | 8.33 | 2.80% | 8.91 | 3.5 |
| 80 | 20 | 97.4 | 2.6 | 7.69 | 2.80% | 7.94 | 1 |
| 80 | 20 | 97.3 | 2.7 | 7.41 | 2.80% | 7.62 | 1.2 |

### Example 2. PH Effect on Silica Generation

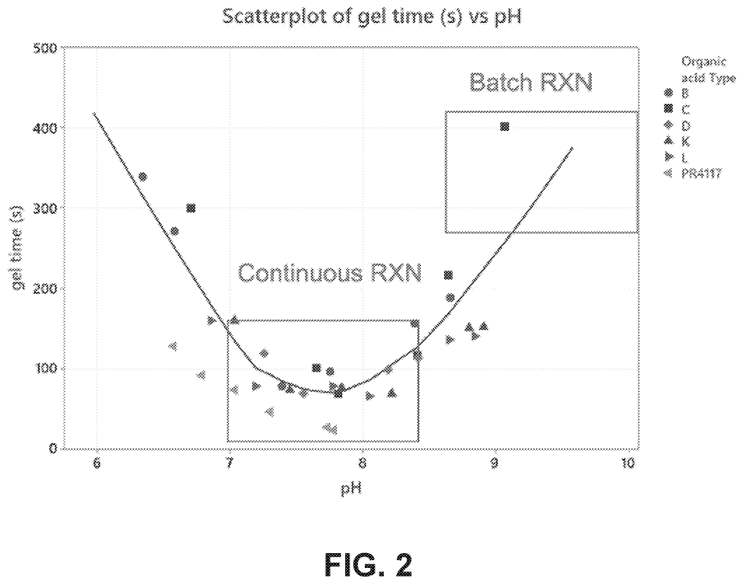

For product quality control, it is recommended to perform the batch reaction in the pH 8.5-10 range. Lowing the pH using different acids (Table 2) increases the reaction speed but also increases the gelling propensity as shown in FIG. 2. Increased reaction speed is more suitable for a continuous reaction, which happens directly in the process pipe. The total reaction time is determined by the flow rate and the pipe size, both which are difficult parameters to adjust.

TABLE 2
Acids

| Acid | Description |
|---|---|
| B | Citric acid |
| C | Butanetetracarboxylic acid |
| D | Cyclopentanetetracarboxylic acid |
| K | Malic acid |
| L | Succinic acid |
| PR-4117 | Polyacrylic acid |

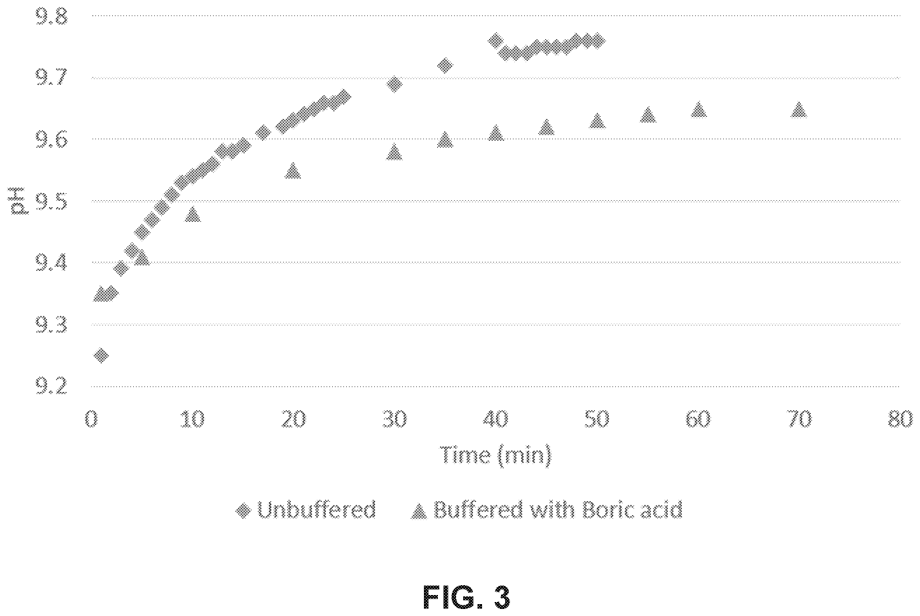

In this reaction, to better tolerate raw material perturbation on the caustic/acid ratio, the proposed batch method uses a buffer comprising an acid to better control the pH in a narrower range. Boric acid, with pKa close to 9.2, is an advantageous as it is in the middle of the preferred pH range. As shown in FIG. 3, the pH swing in the reaction is smaller with 15% of mole ratio buffer involved.

### Example 3. Effect of Turbidity, Viscosity and S-Value on Reaction Time

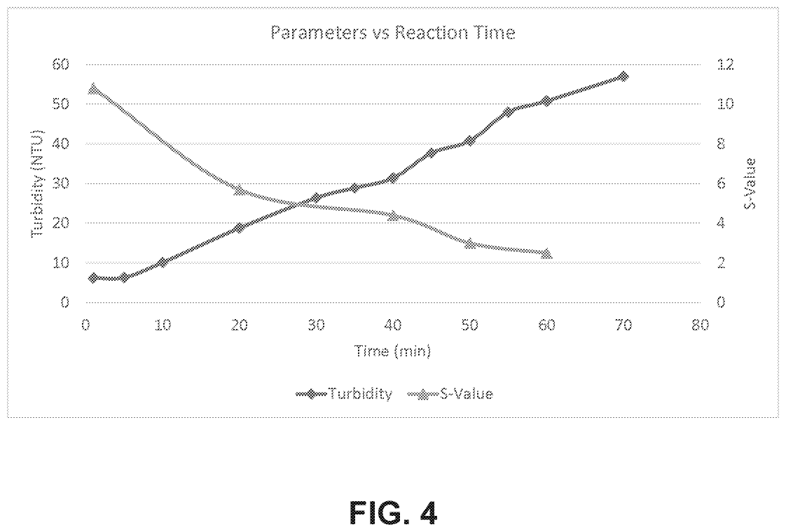

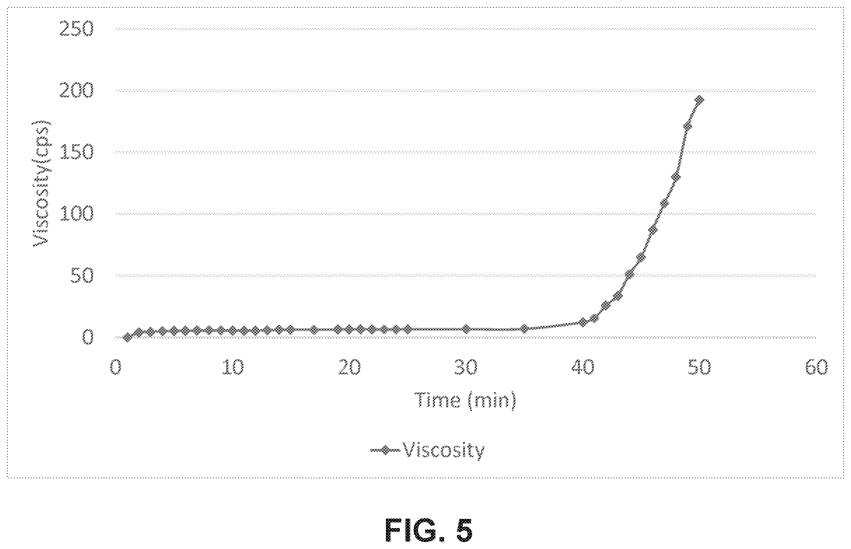

Turbidity was chosen as the measurement used to determine when to terminate the reaction since it is a linear response and easy to monitor (FIG. 4). Viscosity would be a difficult parameter to monitor because it remains steady for a very long time and then sharply increases at the end of the reaction (FIG. 5). The S-value of the silica, which is an indication of the aggregation of the silica particles changes over time (FIG. 4). And viscosity and turbidity also change in the process.

### Example 4. Performance of Generated Unmodified Silica

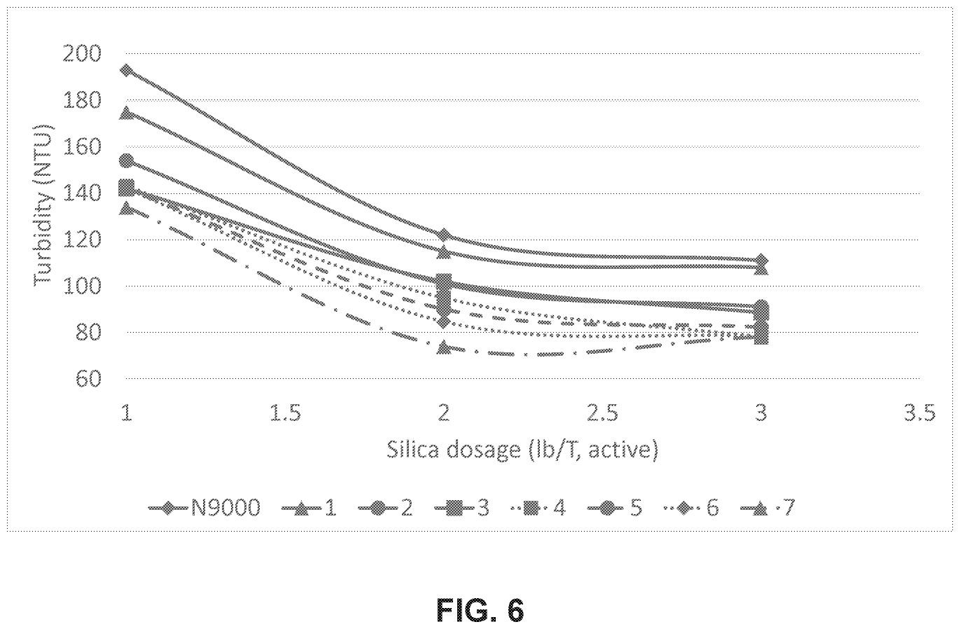

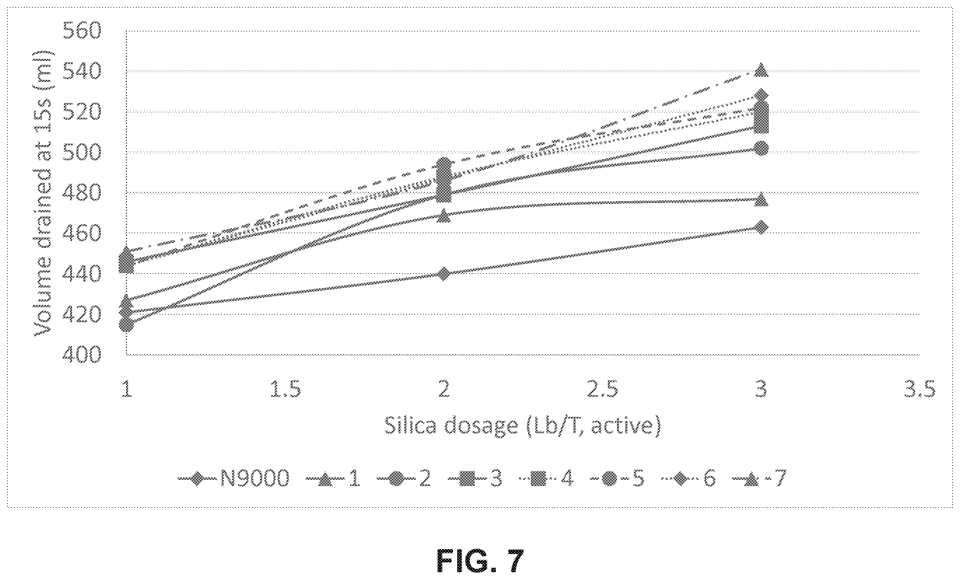

Silica at 1% solid, highly structured from the on-site generation skid. FIG. 6 and FIG. 7 are the performance comparison for sample taken at different reaction time with benchmark N9000 (Table 3).

TABLE 3
Drainage volume at 15 seconds for samples and benchmark N9000

| Sample ID | Reaction Time (min) | Silica Turbidity (NTU) |
|---|---|---|
| N9000 | N/A | N/A |
| 1 | 3 | 5.36 |
| 2 | 10 | 11.1 |
| 3 | 25 | 21.8 |
| 4 | 35 | 29.6 |
| 5 | 45 | 41.3 |
| 6 | 60 | 49.4 |
| 7 | 75 | 61 |

### Example 5. Performance of Generated Modified Silica

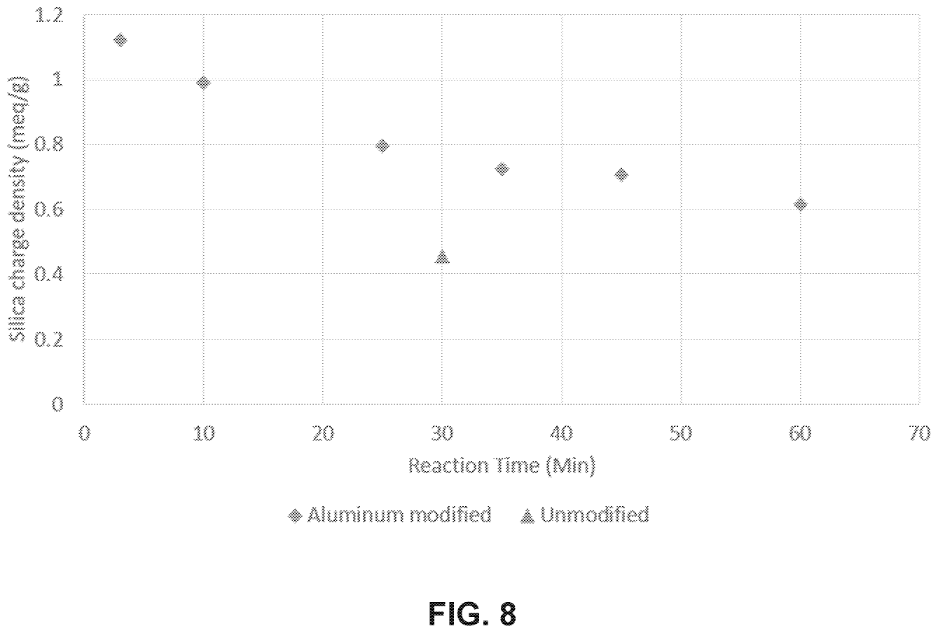

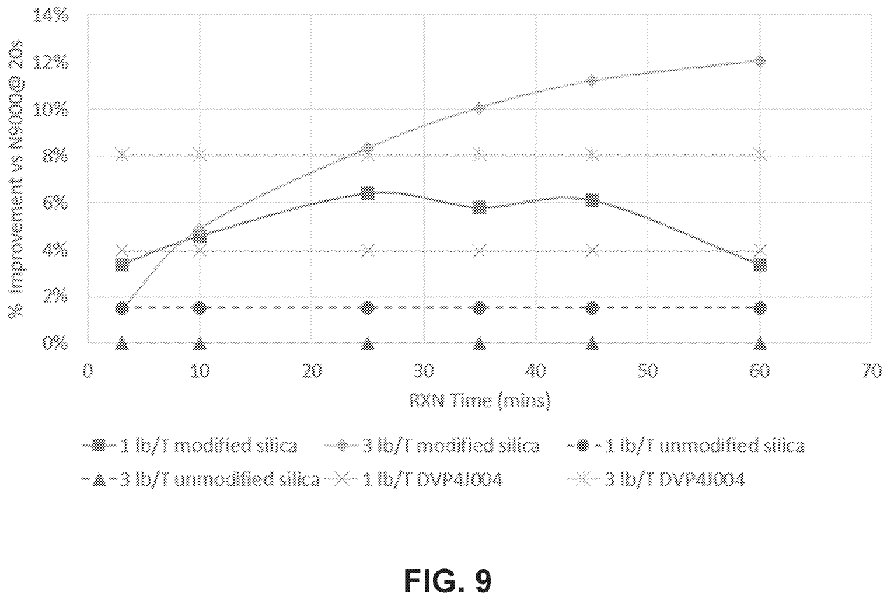

Silica at 0.7% solid, aluminum modified and highly structured from the on-site generation reaction. Table 4 is the performance comparison for sample taken at different reaction time with benchmark N9000. The unmodified sample was taken at 30 mins of reaction, but no aluminum was added for surface modification (FIG. 8). DVP4J004 is the existing aluminum modified silica product from plant, with 10.5% solid content and S-value of about 30. The furnish pH was adjusted to 5.5 for this performance comparison (FIGS. 9 & 10).

TABLE 4
Drainage improvement of samples over N9000 benchmark

| Sample ID | Reaction Time (min) | Turbidity (NTU) |
|---|---|---|
| 1 | 3 | 4.82 |
| 2 | 10 | 8.21 |
| 3 | 25 | 21.8 |
| 4 | 35 | 27.7 |
| 5 | 45 | 34.2 |
| 6 | 60 | 46 |
| Unmodified | 30 | 25 |

### Example 6. On-Site Generated Silica with Enhanced Performance and Storage Stability

Eight (8) reactions were carried out. Each reaction was first heeled with heel water (water glass water) and water glass. A citric acid monohydrate solution was added into the water glass solution. After citric acid monohydrate addition, the reaction, which was carried out in the SiO₂% reaction tank, was referred to as “SiO₂ reaction”. Each reaction was monitored by pH and turbidity change. In addition, each reaction was terminated before reaching a turbidity of 50 NTU. The termination pH depended on the reaction solid content and the added citric acid monohydrate amount. It is understood that, typically, a lower reaction SiO₂% may require a higher acid dosage to allow the reaction to progress in a desirable amount of time, and that this higher acid dosage may result in a lower termination pH value. For example, one reaction (Reaction A) had a reaction SiO₂% of 2.99 wt. % and a citric acid monohydrate amount of 8.3 grams (g), and three reactions (Reaction B, Reaction C, and Reaction D) had a reaction SiO₂ wt. % of 4.07% and a citric acid monohydrate amount of 7.7 g. As a result, the pH measured at the 1^{st} min and 15^{th} min of reaction of Reaction A was lower than Reactions B-D.

Water glass water (Water A) and citric acid monohydrate water (Water B) were the waters used for each of Reaction Nos. 1-5 (Table 5). Water A and Water B could be used at different proportions once the total reaction water was sufficiently added. Typically, citric acid monohydrate is solubilized to provide a solution having a citric acid monohydrate concentration of about 10 wt. % to about 50 wt. %, which may ensure acid addition efficiency. After the turbidity and the pH reached their predetermined values, each reaction was terminated with termination water. Addition of termination water could be divided in multiple stages by mixing into reaction tank or other inline mixing apparatus.

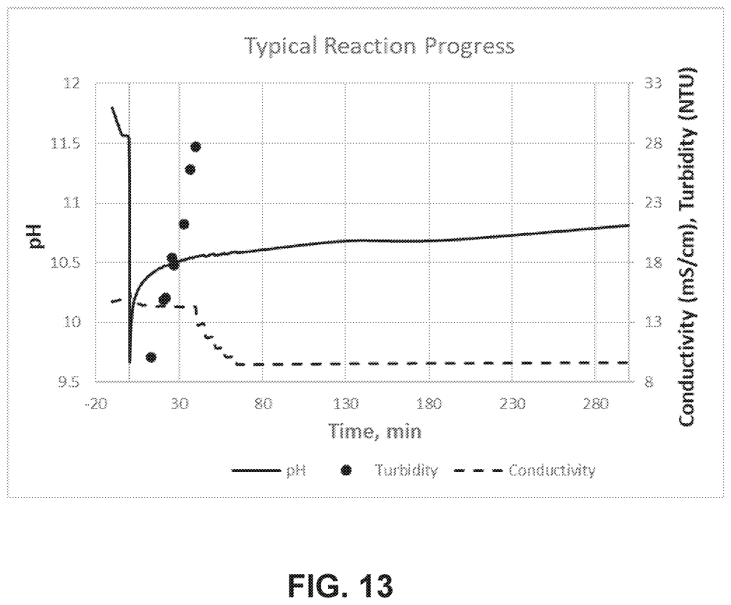

A representative reaction progression graph is shown in FIG. 13.

For each reaction, the starting pH measurement was measured 5 min after a dilute acid solution was completely added into the water glass solution. It is understood that a 5 min period of time may allow for the acid to be fully mixed with the water glass.

For each reaction, the termination pH measurement was conducted just before the dilution water (i.e., the termination water) was added to the reactants to stop reaction.

For each reaction, the product pH measurement was conducted 6 hours after the final dilution water was added to the reactants. It is understood that after dilution water is added, the reaction is significantly slowed down but may not be completely stopped immediately.

For each reaction, the product pH was still slowly increasing after 6 hours of stabilization. It is understood that this may be due to silica nanoparticles agglomerating into larger network with a slightly lower charge density due to condensation reactions releasing free OH.

Therefore, a wider range for the product pH is needed to cover the final product.

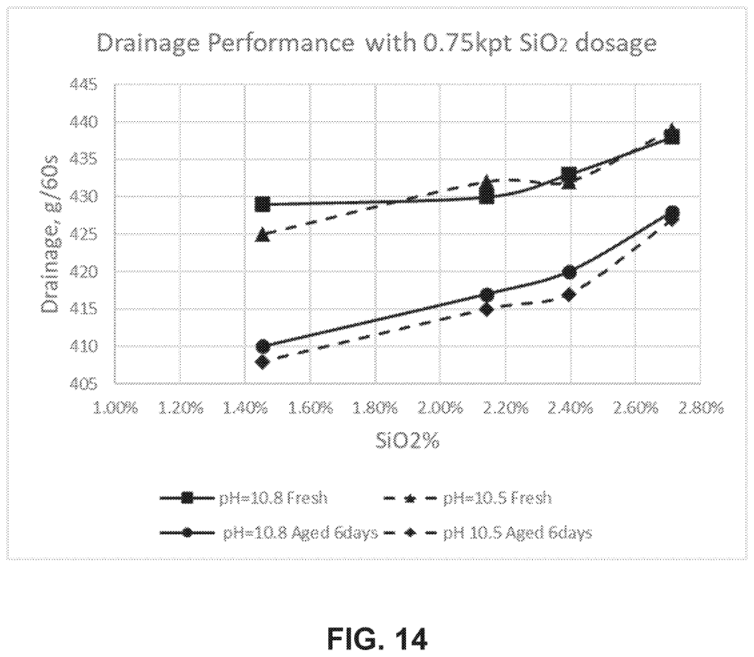

As shown in FIG. 14, a higher product SiO₂% led to better drainage performance for both fresh and aged samples.

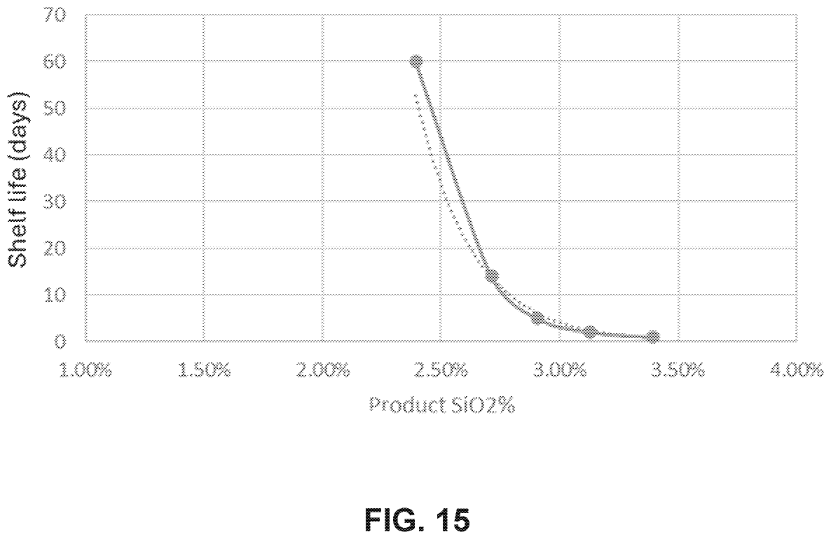

It is understood that the product SiO₂% not only affects the drainage performance of the final product, but it also impacts the product shelf life. For example, for products with a similar product pH at around 10.9, products with 3.4 wt. % SiO₂ may only last about 1 day before gelation (FIG. 15).

TABLE 5
Details Related to Reaction Nos. 1-5

| | Water | | | | | | | | | | | | |
|---|---|---|---|---|---|---|---|---|---|---|---|---|---|
| | Glass | Water | Acid | | Boric | | SiO₂ % | Product | | | Product | Product | Gel |
| Reaction | Water | Glass | Water | CAM | Acid | Term | reaction | SiO₂ % | 1 min | 15 min | pH | pH | Time |
| No. | (g) | (g) | (g) | (g) | (g) | water | (wt. %) | (wt. %) | pH | pH | 6 hours | 45 days | (min) |
| 1 | 60 | 60.8 | 260 | 7.4 | — | 271.7 | 4.39 | 2.58 | 9.98 | 10.44 | 10.90 | 11.35 | 51 |
| 2 | 90 | 60.8 | 260 | 7.6 | — | 124.7 | 4.07 | 3.13 | 9.93 | 10.38 | 10.92 | 11.41 | 55 |
| 3 | 90 | 60.8 | 260 | 8 | — | 293.0 | 4.06 | 2.39 | 9.90 | 10.32 | 10.88 | 11.42 | 22 |
| 4 | 150 | 60.8 | 290 | 8.5 | — | 690.7 | 3.34 | 1.42 | 9.48 | 9.98 | | | 40 |
| 5 | 90 | 60.8 | 267.1 | 7.3 | 1.2 | 752.9 | 3.80 | 1.42 | 10.00 | 10.35 | | | 56 |

Term = termination;
CAM = citric acid monohydrate

The water glass used was a sodium silicate solution in water.
Water glass water refers to the water used as the solvent to prepare the water glass solution.
Acid water refers to the water used as the solvent to prepare the acid (CAM) solution.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a device” is intended to include “at least one device” or “one or more devices.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all viscosities were measured using a Brookfield viscometer with an ultra-low viscosity adapter.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

1. A process for preparing silica, comprising:
adding a silicate to water to form a first mixture;
adding an acid to the first mixture to form a second mixture;
mixing the second mixture to produce silica until a predetermined turbidity value and/or a predetermined pH value has been achieved; and
adding a termination water to the second mixture when the predetermined turbidity value and/or the predetermined pH value has been achieved to form a third mixture,
wherein the third mixture has a silica concentration of about 0.1 wt. % to about 5 wt. %.

2. The process of claim 1, wherein the silicate is selected from the group consisting of sodium silicate, calcium silicate, ammonium silicate, potassium silicate, and any combination thereof.

3. The process of claim 1, wherein the acid comprises an organic acid.

4. The process of claim 1, wherein the acid comprises an inorganic acid.

5. The process of claim 3, wherein the acid comprises formic acid, acetic acid, itaconic acid, citric acid, butanetetracarboxylic acid, cyclopentane tetracarboxylic acid, malic acid, succinic acid, acrylic acid, polyacrylic acid, or any combination thereof.

6. The process of claim 4, wherein the acid comprises sulfamic acid, nitric acid, hydrochloric acid, sulfuric acid, or any combination thereof.

7. The process of claim 1, wherein the second mixture has a pH of about 8 to about 11.

8. The process of claim 1, wherein the predetermined pH value is from about 9 to about 12.

9. The process of claim 1, wherein the third mixture has a pH value of about 9 to about 12.

10. The process of claim 1, wherein the third mixture has a silica concentration of about 3.1 wt. % to about 5 wt. %.

11. The process of claim 1, wherein the third mixture comprises a silica having an S-value of about 2 to about 25 or about 21 to about 25.

12. The process of claim 1, wherein the third mixture has a conductivity of about 3000 μS/cm to about 6000 μS/cm per 1% SiO₂.

13. The process of claim 1, further comprising adding an aluminate salt, an aluminum salt, or a combination thereof, to the third mixture to form a modified silica.

14. The process of claim 1, further comprising adding a buffer to the first mixture, the second mixture, and/or the third mixture, or excluding adding a buffer to the first mixture, the second mixture, and/or the third mixture.

15. A process for preparing silica, comprising:
adding a silicate to water to form a first mixture;
adding an acid to the first mixture to form a second mixture, wherein the second mixture comprises a pH of about 8 to about 11;
mixing the second mixture to produce silica until a predetermined turbidity value and/or a predetermined pH value has been achieved; and
adding a termination water to the second mixture when the predetermined turbidity value and/or the predetermined pH value has been achieved to form a third mixture, wherein the third mixture has a silica concentration of about 0.1 wt. % to about 5 wt. % and a pH value of about 9 to about 12.

16. A silica composition prepared by:
adding a silicate to water to form a first mixture;
adding an acid to the first mixture to form a second mixture, wherein the second mixture comprises a pH of about 8 to about 11;
mixing the second mixture to produce silica until a predetermined turbidity value and/or a predetermined pH value has been achieved; and
adding a termination water to the second mixture when the predetermined turbidity value and/or the predetermined pH value has been achieved to form a third mixture, wherein the third mixture has a silica concentration of about 0.1 wt. % to about 5 wt. % and a pH value of about 9 to about 12.

17. The silica composition of claim 16, wherein the third mixture has a silica concentration of about 3.1 wt. % to about 5 wt. %.

18. The silica composition of claim 16, wherein the third mixture comprises a silica having an S-value of about 2 to about 25 or about 21 to about 25.

19. The silica composition of claim 16, wherein the composition is free from a gel for at least about 60 days.

20. A method of improving drainage in a papermaking process comprising adding the silica composition of claim 16 to a papermaking furnish.
